(19) United States
(12) Patent Application Publication
(10) Pub. No.: US 2009/0073399 A1
(43) Pub. Date: Mar. 19, 2009

(54) EXPOSURE APPARATUS

(75) Inventors: Takahito Chibana, Utsunomiya-shi (JP); Hitoshi Nakano, Utsunomiya-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/211,158

(22) Filed: Sep. 16, 2008

(30) Foreign Application Priority Data
Sep. 19, 2007 (JP) 2007-241740

(51) Int. Cl. G03B 27/52

(52) U.S. Cl. 355/30

(57) ABSTRACT

An exposure apparatus of the present invention is configured to flow liquid in an area between an optical element 5 of a projection optical system and a wafer and to expose a pattern on a reticle onto the wafer via the projection optical system. The exposure apparatus includes a supply port 12 configured to supply the liquid 18 to the area, a recovery port 13 configured to recover the liquid 18 from the area, a plane plate 22 configured to be movably positioned, a suction port 23 which is provided on the plane plate 22 and is configured to suction at least one of the liquid 18 and a gas, and a drive unit 27 configured to move a position of the suction port 23 by driving the plane plate 22 in parallel to a surface of the plane plate when the suction port 23 suctions at least one of the liquid 18 and the gas. The drive unit 27 drives the plane plate 22 to move the suction port 23 in a range broader than an exposure area.

### BACKGROUND OF THE INVENTION

The present invention relates to an exposure apparatus which exposes a pattern of an original plate onto a wafer to be exposed via a projection optical system, and more particularly to an immersion exposure apparatus in which an area between the projection optical system and the wafer to be exposed is filled with liquid.

In a process of manufacturing a semiconductor device configured by fine patterns such as an LSI or an ULSI, a reduced projection exposure apparatus in which a pattern formed on a mask is projected onto a wafer on which a photosensitizing agent has been coated is used. The exposure apparatus is required to further miniaturize patterns in accordance with the improvement of the integration density of semiconductor devices, and it has responded to the miniaturization in accordance with the development of resist processes.

In order to improve the resolution of an exposure apparatus, generally speaking, it needs to shorten an exposure wavelength or enlarge numerical aperture (NA) of a projection optical system.

With regard to the exposure wavelength, KrF excimer laser which has an oscillation wavelength of around 248 nm is shifting to ArF excimer laser which has an oscillation wavelength of around 193 nm. Furthermore, fluorine (F₂) excimer laser which has an oscillation wavelength of around 157 nm is also developing.

On the other hand, as an entirely different technology for improving the resolution, there is an immersion method. Conventionally, a space between a surface of a final lens of the projection optical system and a surface of the substrate (wafer) to be exposed was filled with a gas (air). However, in the immersion method, this space is filled with liquid to perform a projection exposure. The advantage of the immersion method is to improve the resolution.

For example, when the immersion liquid is pure water (the refractive index is 1.44) and a maximum incident angle of a light beam which forms an image on a wafer is assumed to be equal between the immersion method and the conventional one, even if a light source which has a wavelength identical to the conventional one is used, the resolution of the immersion method improves 1.44 times as much as the conventional one. This is equivalent to increasing the numerical aperture NA 1.44 times as much as the projection optical system of the conventional method. Therefore, according to the immersion method, it is possible to obtain the resolution more than NA=1, which was conventionally impossible.

As a method for filling the space between the surface of the final lens of the projection optical system and the surface of the wafer with the liquid, broadly speaking, two methods are proposed. One method is a method in which whole of a final lens of the projection optical system and a wafer are positioned in a liquid tank. The other is a local fill method in which liquid flows only the space sandwiched between a surface of an optical element of the projection optical system and a surface of a wafer.

In an exposure apparatus using the immersion method, the space between the surface of the final lens of the projection optical system and the surface of the wafer needs to be filled with the liquid (initial filling of the liquid) before exposing the wafer. As a method for performing the initial filling, Japanese Patent Laid-Open No. 2006-074061 discloses a configuration in which a wafer stage which holds a wafer is moved while supplying liquid, and the space between a surface of a final lens of a projection optical system and a surface of a wafer is filled with the liquid.

Japanese Patent Laid-Open No. 2006-074061 discloses a configuration in which a suction port which suctions liquid is provided on a plane plate having a surface which has a height substantially equal to a wafer, and an initial filling is performed in the state where a surface of a final lens of a projection optical system is opposed to the suction port.

Japanese Patent Laid-Open No. 2006-140459 discloses a configuration in which a removal device which removes foreign substances inside a concave part is positioned if the surface of the final lens of the projection optical system has the concave part.

In an exposure apparatus using the immersion method, it is important to avoid the influence for the exposure by a bubble in the liquid. If a small bubble is intruded to the exposure area between the surface of the final lens of the projection optical system and the wafer, the exposure light is scattered. If a large bubble is intruded to the area, a part in which there is no liquid in the exposure area is generated. Therefore, a line width of a pattern to be transferred varies beyond the range that is permissible and an exposure defect is generated. As a result, there is a problem in which the productivity of the exposure apparatus is deteriorated.

In particular, a bubble is likely to be generated when the process of the initial filling of the liquid is performed. This is caused by the existence of a step, a groove, a gap, or an edge part in the space that is to be filled with the liquid, or caused by the difference of the surface condition. In the space between the surface of the final lens of the projection optical system and the wafer, it is preferable that there is ideally no change of the surface condition in the area where the condition changes from a liquid-unfilled condition to a liquid-filled condition. In other words, it is preferable that there is no step, groove, gap, and edge part, and whole of the surface condition such as a roughness of the surface or a hydrophilic nature with respect to liquid is the same. Under such a condition, the space between the surface of the final lens of the projection optical system and the wafer can be smoothly filled with the liquid without generating any bubbles.

However, in an actual exposure apparatus, there are steps, grooves, gaps, or edge parts, or there is an area where the surface condition is different from that of another area in the space to be filled with the liquid. Therefore, at the time of the initial filling of the liquid, a bubble is trapped at these parts. This aspect will be described with reference to FIGS. 11 to 13. FIG. 11 is a schematic side view for describing an initial filling of a liquid in a conventional immersion exposure apparatus, which shows the state before filling the liquid. FIG. 12 shows the state where the liquid has been filled between a final lens 101 and a wafer 105, using a supply port 102 and a recovery port 103 provided on a nozzle 104 in an exposure apparatus of FIG. 11. FIG. 13 is a plan view of a section of the space between the wafer 105 and the final lens 101, and the final lens 101 and the nozzle 104 are looked up from the bottom in FIG. 12.

As shown in FIG. 11, in the conventional exposure apparatus, there are a gap and an edge part between the final lens 101 and the nozzle 104. If there are the gap and the edge part, a bubble is likely to be trapped at the part. Therefore, as shown in FIGS. 12 and 13, a bubble sometimes remains in liquid 106 even after the space between the final lens 101 and the wafer 105 is filled with the liquid 106. Since the liquid 106 moves around the bubble, even if a continuous supply and recovery of the liquid is performed after the initial filling, the trapped bubble can not be removed. Furthermore, the bubble trapped at the edge part can not be put outside even if the wafer 105 is moved, and the bubble remains to stay in the liquid 106. Therefore, an exposure defect increases and the productivity of the exposure apparatus is deteriorated.

### BRIEF SUMMARY OF THE INVENTION

The present invention was made in view of the above points, and provides an exposure apparatus in which a bubble generated in the immersion area can be effectively removed at the time of initial filling of the liquid.

An exposure apparatus as one aspect of the present invention is configured to flow liquid in an area between an optical element of a projection optical system and a wafer and to expose a pattern on a reticle onto the wafer via the projection optical system. The exposure apparatus includes a supply port configured to supply the liquid to the area, a recovery port configured to recover the liquid from the area, a plane plate configured to be movably positioned, a suction port which is provided on the plane plate and is configured to suction at least one of the liquid and a gas, and a drive unit configured to move a position of the suction port by driving the plane plate in parallel to a surface of the plane plate when the suction port suctions at least one of the liquid and the gas. The drive unit drives the plane plate to move the suction port in a range broader than an exposure area.

Further features and aspects of the present invention will become apparent from the following description of exemplary embodiments with reference to the attached drawings.

### BRIEF DESCRIPTION OF THE DRAWINGS

FIG. 1 is a side view showing a schematic configuration of a projection exposure apparatus that is embodiment 1 of the present invention.

FIG. 2 is a side view showing a schematic configuration of an area adjacent to an optical element of a projection exposure apparatus that is embodiment 1 of the present invention.

FIG. 3 is a side view showing a schematic configuration of an area adjacent to an optical element when an initial filling of liquid is performed in a conventional projection exposure apparatus.

FIGS. 4A and 4B are side views showing a schematic configuration of an area adjacent to an optical element for explaining the effect of a projection exposure apparatus that is embodiment 1 of the present invention.

FIGS. 5A to 5D are sides view showing a schematic configuration of an area adjacent to an optical element for explaining the process of initial filling in a projection exposure apparatus that is embodiment 1 of the present invention.

FIG. 6 is a side view showing a schematic configuration of an area adjacent to an optical element for explaining the effect of a projection exposure apparatus that is embodiment 2 of the present invention.

FIG. 7 is a side view showing a schematic configuration of an area adjacent to an optical element for explaining the effect of a projection exposure apparatus that is embodiment 2 of the present invention.

FIG. 8 is a side view showing a schematic configuration of an area adjacent to an optical element of a projection exposure apparatus that is embodiment 3 of the present invention.

FIG. 9 is a side view showing a schematic configuration of an area adjacent to an optical element of a projection exposure apparatus that is embodiment 4 of the present invention.

FIG. 10 is a plan view looking down a plane plate of a projection exposure apparatus that is embodiment 4 of the present invention from the above.

FIG. 11 a schematic side view of a conventional immersion exposure apparatus.

FIG. 12 is a schematic side view for explaining initial filling of liquid in a conventional immersion exposure apparatus.

FIG. 13 is a schematic plan view for explaining initial filling of liquid in a conventional immersion exposure apparatus.

FIG. 14 is a flowchart at the time of initial filling of liquid in an exposure apparatus that is embodiment 1 of the present invention.

### DETAILED DESCRIPTION OF THE PREFERRED EMBODIMENTS

Exemplary embodiments of the present invention will be described below with reference to the accompanied drawings.

### Embodiment 1

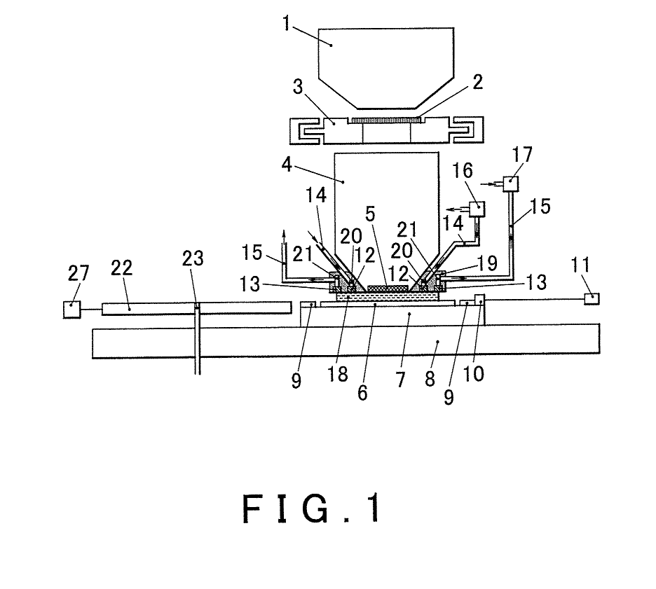

FIG. 1 is a schematic side view of a step-and-scan type projection exposure apparatus which can be applied to the present embodiment. The exposure apparatus of the present embodiment is directed to an exposure apparatus using an immersion method, and more particularly to an exposure apparatus using a local fill method that flows liquid in a space (an area) between an optical element (a final lens) of a projection optical system and a substrate (a wafer).

In FIG. 1, light emitted from an exposure light source (not shown) such as ArF excimer laser or F₂ excimer laser is provided to an illumination optical system 1. The illumination optical system 1 illuminates a part of a reticle 2 (an original plate, or a mask) by slit light (light that has a cross-sectional shape like being formed by passing through a slit), using light provided from the exposure light source. During illuminating the reticle 2 by the slit light, a reticle stage (an original plate stage) 3 which holds the reticle 2 and a wafer stage (a substrate stage) 7 which holds a wafer (a substrate) 6 move to scan so that one of the stages is synchronized with the other. By such a synchronized scan, whole pattern on the reticle 2 continuously forms an image on the wafer 6 via the projection optical system 4, the resist coated on the surface of the wafer 6 is exposed. The wafer stage 7 is mounted on a wafer stage platen 8.

In FIG. 1, reference numeral 10 denotes an X-direction length measuring mirror which is fixed and provided on the wafer stage 7. Reference numeral 11 is an X-direction laser interferometer which measures a position in an X-direction of the wafer stage 7. Similarly, a Y-direction length measuring mirror (not shown) is fixed and provided on the wafer stage 7, and a Y-direction laser interferometer (not shown) which measures a position in a Y-direction of the wafer stage 7 is provided. Thus, the position in a Y-direction of the wafer stage 7 is measured. A measuring mirror (not shown) is also provided on the reticle stage 3, and the position of the reticle stage 3 is measured by a laser interferometer (not shown) which measures the position of the reticle stage 3.

The position of the reticle stage 3 or the wafer stage 7 is measured by each interferometer in real time. A controller (not shown) performs a positioning or a synchronous control of the reticle 2 (the reticle stage 3) or the wafer 6 (the wafer stage 7) based on the obtained measured value. The wafer stage 7 includes a drive unit which adjusts, changes, or controls the position in an upward or a downward direction (vertical direction), a rotational direction, or a tilt of the wafer 6.

The drive unit controls the wafer stage 7 so that an exposure area on the wafer 6 is always aligned on a focal plane of the projection optical system 4 with high accuracy. The position of the surface on the wafer 6 (the position in an upward and downward directions and the tilt) is measured by a focus sensor (not shown) and is provided to the controller (not shown).

An almost enclosed space is formed in a space around the vicinity of the wafer stage 7 and a final lens (an optical element 5) of the projection optical system 4. A gas (an air) controlled to be a predetermined temperature and humidity is blown from an air conditioner (not shown) into the space. Thus, the space around the wafer stage 7 and the optical element 5 that is a final lens is kept at a predetermined temperature. Similarly, an almost enclosed space is formed in the space around the reticle stage 3, and a conditioned gas (a conditioned air) is blown. Thus, the space around the reticle stage is kept at a predetermined temperature.

A nozzle 19 is provided so as to surround the optical element 5. The nozzle 19 is provided with a supply port 12 (details will be described later) for supplying liquid 18 into a space between the optical element 5 and the wafer 6 (an immersion area). The supply port 12 surrounds the periphery of the optical element 5 and is positioned so as to be opposed to the wafer 6. A buffer space 20 is provided on the upper side of the supply port 12. The buffer space 20 is provided so that the liquid supplied from a supply pipe 14 reaches all circumstances of the supply port 12. The buffer space 20 is coupled to a liquid supply device 16 of the liquid via the supply pipe 14 of the liquid.

The nozzle 19 is provided with a recovery port 13 (details will be described later) for recovering the liquid and the gas (air). The recovery port 13 surrounds the supply port 12 and is positioned so as to be opposed to the wafer 6. As is the case with the supply port 12, a buffer space 21 is provided on the upper side of the recovery port 13. The buffer space 21 is coupled to a recovery device 17 of the liquid and the gas via a recovery pipe 15.

In FIG. 1, the supply pipe 14 coupled to the buffer space 20 and the recovery pipe 15 coupled to the buffer space 21 is drawn in the same plane (a plane vertical to the wafer 6) in order to be easily understood. The supply pipe 14 and the recovery pipe 15 are not limited to be arranged in the same plane as shown in FIG. 1. These pipes may be arranged in a different plane from the plane which is vertical to the wafer 6.

Each of the supply port 12 and the recovery port 13 can be simply configured as an opening. However, it is preferable that the supply flow rate or the recovery flow rate of the liquid 18 does not vary depending upon the location and that the supply or the recovery is performed in the state where an in-plane flow velocity distribution is nearly uniform. Therefore, it is preferable that a porous plate on which a plurality of small holes are arranged on the circumstance of circle is used as the supply port 12 or the recovery port 13. A slit which blows a gas from a tiny gap may be used, and a metal or a resin which is used for a filter and the like, a sintered material made of minerals, or a porous member such as a form material and a textile material may also be used. Furthermore, these members may be laminated.

The liquid supply device 16 includes, for example, a tank which is to be filled with the liquid, a pumping device which pumps the liquid, and a flow rate controller which controls a supply amount of the liquid. It is preferable that the liquid supply device 16 further includes a temperature controller for controlling the supply temperature of the liquid. The recovery device 17 of the liquid and the gas includes, for example, a tank which separates the recovered liquid and the recovered gas and is to be temporarily filled with the liquid, a suction device which suctions the liquid and the gas, and a flow rate controller for controlling the recovery amount of the liquid and the gas.

A liquid for the immersion is selected from liquids which absorb only small amounts of an exposure light. Specifically, as a liquid for immersion, pure water, functional water, fluoride liquid such as fluorocarbon, or the like is regarded as a candidate for the liquid for immersion. It is preferable that a dissolved gas has been sufficiently removed from the liquid for the immersion in advance using a degasifier. This is because it reduces the generation of a bubble, and even if the bubble is generated, it can be promptly absorbed in the liquid. For example, with respect to nitrogen and oxygen, large amounts of which are contained in the environment, if 80% or larger of the amount of the gas which is dissolvable in the liquid is removed, the generation of the bubble can be sufficiently reduced. Of course the exposure apparatus may include the degasifier (not shown) and supply the liquid to the liquid supply device 16 while always removing the dissolved gas in the liquid. As a degasifier, for example, a vacuum degasifier in which the liquid flows in one area separated from the other evacuated area by a gas permeable film and the dissolved gas in the liquid is removed to the evacuated area via the film is preferable.

A support plate 9 which has substantially the same height as the wafer 6 is provided around the outside of the wafer 6. The liquid 18 can also be supported at the edge of the wafer 6 in the space between the optical element 5 and the wafer 6 due to the support plate 9, and the exposure at the edge of the wafer 6 is made possible.

A plane plate 22 is provided independently from the wafer stage 7. A suction port 23 (a suction pipe), which suctions the liquid or the gas, or both of them, is positioned on the plane plate 22. The plane plate 22 is positioned movably by a drive unit 27, and is driven independently from the wafer stage 7.

The plane plate 22 is positioned at a position opposed to the optical element 5 at the time of the initial filling of the liquid 18. The initial filling of the liquid 18 is performed above the plane plate 22 which is positioned opposed to the optical element 5. At the time of the initial filling, a space between the optical element 5 and the wafer 6 (an immersion area) is filled with the liquid 18 by supplying the liquid 18 from the supply port 12 of the liquid. At the same time, the liquid is recovered (removed) by the recovery port 13 of the liquid. The suction port 23 is coupled to a suction device (not shown) such as a suction pump or a cylinder. The suction port 23 suctions the liquid or the gas or both of them, at a predetermined time in the time of the initial filling of the liquid 18.

As a member such as the nozzle 19, the support plate 9, and the plane plate 22 which is wetted with the liquid 18, a member such as stainless steel, fluorine resin, or ceramic, which is chemically resistant to be contaminated and easily keeps the cleanliness.

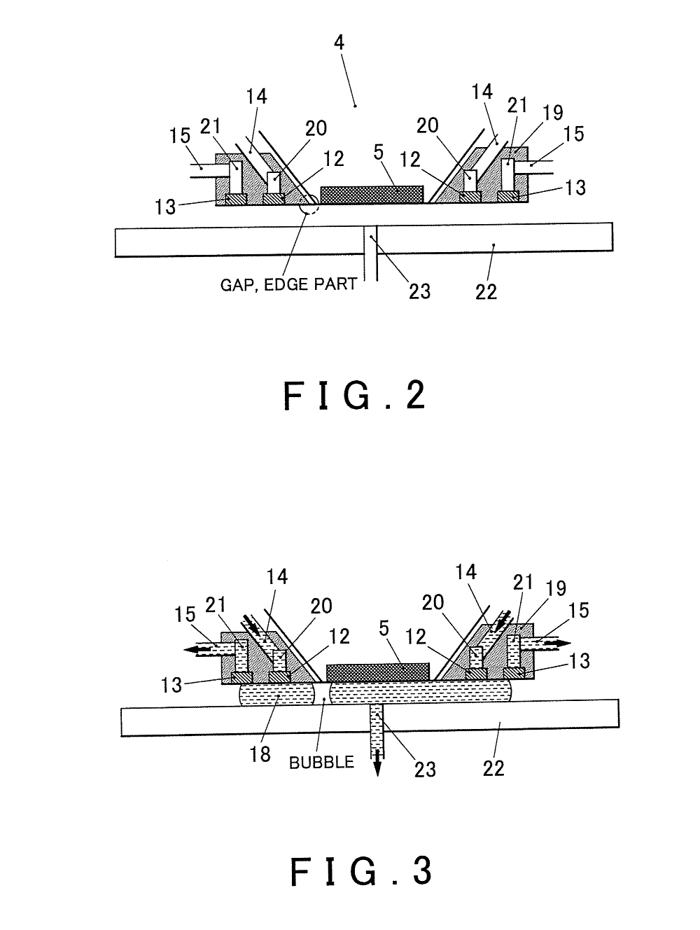

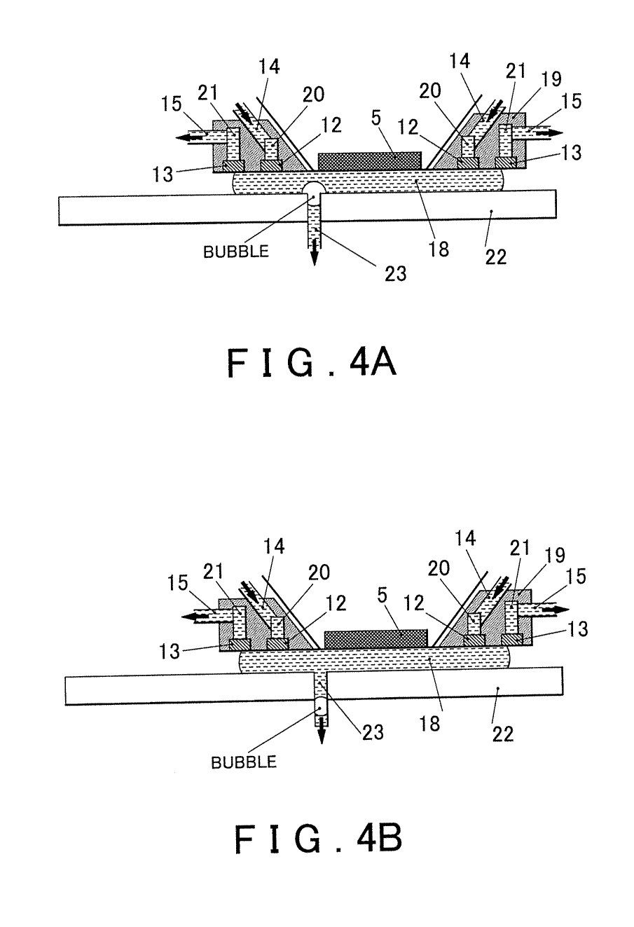

Next, the initial filling of the liquid 18 in the present embodiment will be described with reference to FIGS. 2 to 4. FIG. 2 is a side view showing the schematic configuration of an area adjacent to the optical element 5 when the suction port 23 is positioned at a position opposed to the optical element 5. FIG. 2 shows the state before the initial filling is performed. FIG. 3 is a side view showing the schematic configuration of an area adjacent to the optical element 5 when the initial filling is performed by a conventional method. FIG. 4 is a side view showing the schematic configuration of an area adjacent to the optical element 5 for explaining the effect of the present embodiment. In FIGS. 2 to 4, the same elements as those of FIG. 1 are represented by the same reference numerals, and the description on these elements will be omitted.

As shown in FIG. 2, the exposure apparatus of the present embodiment, as in the case of a conventional one, has a gap and an edge part between the nozzle 19 and the projection optical system 4. Therefore, according to the conventional initial filling method, as shown in FIG. 3, the bubble is sometimes trapped. Even if the flow of the liquid 18 from the supply port 12 to the suction port 23 exists, since the liquid 18 flows around the bubble, the trapped bubble is not removed. Furthermore, the bubble trapped at the edge part or the like is difficult to be put outside even if the plane plate 22 is moved. Once a bubble is trapped, it continues to remain in the liquid 18. Therefore, in exposing the substrate, the exposure defect increases and the productivity of the exposure apparatus is deteriorated.

Although FIG. 3 shows the state where the trap of the bubble occurs at the gap or the edge part, the location where the trap of the bubble occurs is not limited to these part. In exposing, a resist film coated on the wafer 6 or a topcoat film has a possibility of dissolving in the liquid 18 and depositing on the surface of a part of the optical element 5. Thus, when the surface state of the optical element 5 locally changes or the like, the trap of the bubble can occur at the boundary of the area where the surface state changes.

As described above, the trap of the bubble tends to occur at the step, the groove, the gap, the edge part, or the interface of areas where the surface states are different. This is because a large power (energy) needs to be applied to the bubble when the bubble overcomes the step, the groove, the gap, the edge part, or the areas where the surface states are different.

Generally speaking, when the bubble trapped on a surface overcomes the step or the like to move to another surface, the shape largely changes and the surface energy which the bubble has increases. Therefore, when the bubble is moving, an energy larger than the increase in this surface energy needs to be given to the bubble. However, it is frequently not enough even if an external force such as driving a stage is applied to the bubble. Therefore, the bubble can not overcome the step, the groove, the gap, the edge part, or the interface of areas where the surface states are different, and continues to be trapped.

The exposure apparatus of the present embodiment performs to remove the bubble using the state where the trapped bubble does not move. Even if the plane plate 22 is driven in a plane parallel to a main surface of the wafer 6, the bubble does not move. Therefore, the plane plate 22 is driven so that the suction port 23 is positioned immediately below the bubble. As shown in FIGS. 4A and 4B, the bubble can be effectively removed by moving the suction port 23 immediately below the bubble, in other words, immediately below the gap, or the edge part.

In FIG. 4, in order to be easily understood, the plane plate 22 is driven so that the suction port 23 is positioned immediately below the bubble. However, actually, it is difficult to assume the position where the bubble is trapped. Therefore, it needs to assume that the bubble can be trapped at every area. Therefore, it is preferable that the suction port 23 is in an open state and that the plane plate 22 is driven while suctioning the liquid 18. The trapped bubble can be effectively removed even if the bubble is trapped at every area, by driving the plane plate 22 while suctioning the liquid 18. As a result, the risk that the bubble remains in the liquid 18 can be reduced.

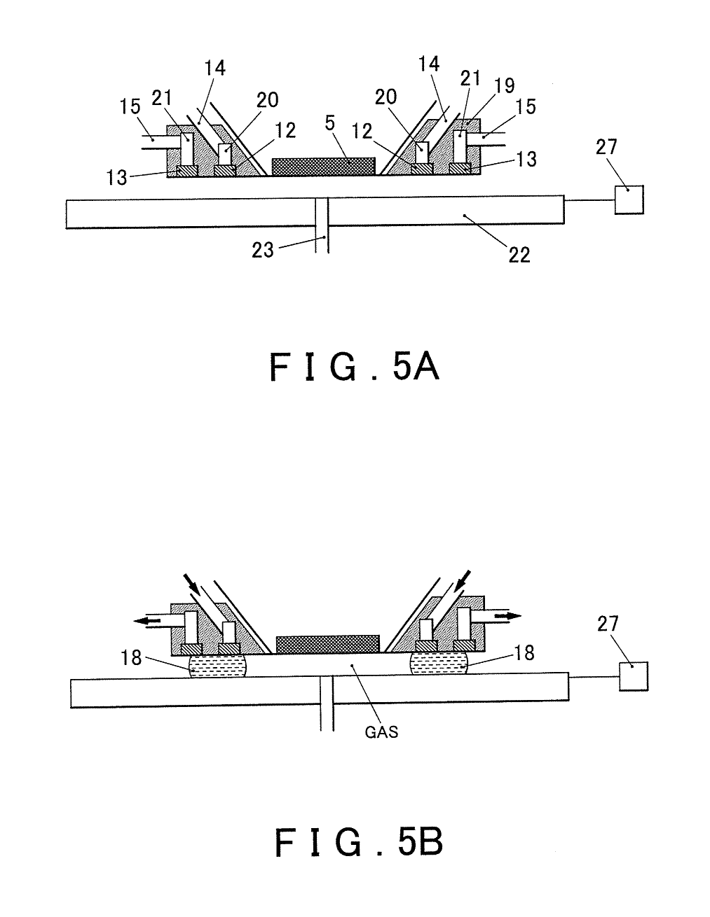

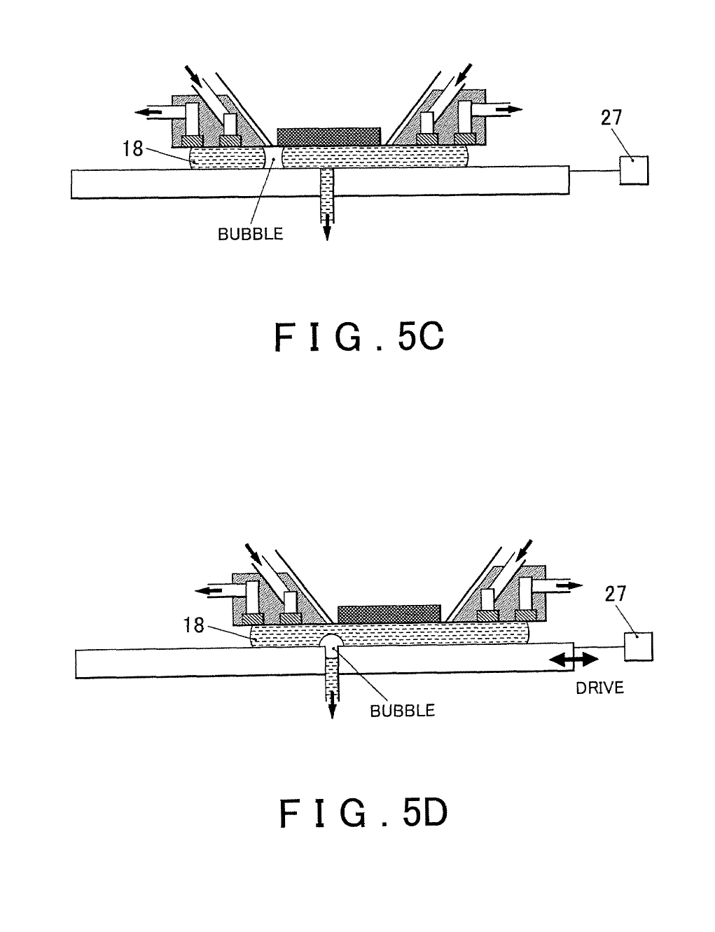

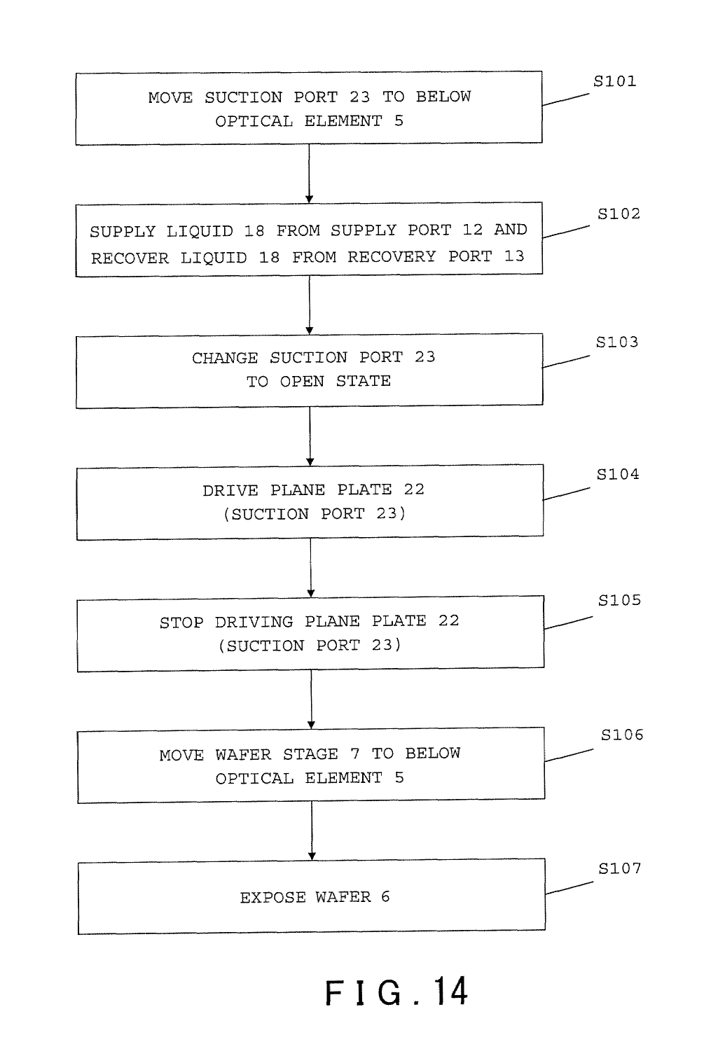

A method of the initial filling of the liquid 18 will be described in detail with reference to FIGS. 5A to 5D and FIG. 14.

FIGS. 5A to 5D are side views showing the schematic configuration of an area adjacent to the optical element 5 when the plane plate 22 is positioned at a position opposed to the optical element 5, which show the process of initial filling. FIG. 14 is a flowchart at the time of initial filling of the liquid 18.

At the time of the initial filling of the liquid 18, first, the plane plate 22 is moved so that the suction port 23 is positioned at a position opposed to the optical element 5. Thus, the suction port 23 moves to below the optical element 5 (FIG. 14: Step S101). In this state, the liquid 18 is supplied from the supply port 12 to the immersion area, and the liquid 18 is recovered by the recovery port 13 (FIG. 5A, FIG. 14: Step S102).

The liquid 18 supplied to the immersion area forms an annular shape in accordance with the arrangement of the supply port 12 while remaining a gas at the central part between the optical element 5 and the plane plate 22 (FIG. 5B). Then, the suction port 23 suctions the liquid 18 or the internally residual gas (bubble) by opening the suction port 23 (FIG. 14: Step S103).

The open timing in Step S103 can be set so as to open the suction port 23 after a predetermined time elapses since the supply of the liquid 18 starts, by providing a timer circuit.

A liquid amount detector which is configured to detect a liquid amount of the liquid 18 in the immersion area can also be provided. In this case, the suction port 23 can be set so as to be opened when the liquid amount detected by the liquid amount detector is larger than a predetermined value.

The liquid 18 is forcibly drawn to the suction port 23 by the suction, and starts to rapidly flow in the direction of the suction port 23. As time passes, most parts below the optical element 5 are filled with the liquid 18. However, as shown in FIG. 5C, the bubble (the gas) is sometimes trapped at the edge part or the like.

Therefore, when the suction port 23 suctions the liquid 18 or the bubble, the plane plate 22 is driven in parallel to the surface of the plane plate and the position of the suction port 23 is moved (FIG. 14: Step S104). At this time, the suction port 23 is kept in the open state, and the suction from the suction port 23 continues and the suction port 23 passes immediately below the bubble.

The plane plate 22 is driven by the drive unit 27 so as to move in parallel to the surface of the plane plate 22. Since the plane plate 22 moves in parallel to the surface, the suction port 23 provided on the plane plate 22 moves the immersion area and passes immediately below the bubble formed in the immersion area. Thus, the bubble is removed via the suction port 23 (FIG. 5D). Therefore, the bubble generated in the liquid 18 between the optical element 5 and the plane plate 22 can be effectively removed, and the risk that the bubble remains in the liquid 18 can be reduced.

As a drive timing in Step S104, a timer circuit can be provided and can be set so that the plane plate 22 is driven after a predetermined time elapses since the suction port 23 is changed to the open state. A liquid detector configured to detect a liquid amount of the liquid 18 in the immersion area can be provided, and also can be set so as to open the suction port 23 when the liquid amount detected by the liquid detector is larger than a predetermined value.

In the present embodiment, the plane plate 22 (the suction port 23) starts to be driven after the suction port 23 is changed to the open state (FIG. 14: Steps S103 and S104). However, the present embodiment is not limited to this. For example, the plane plate 22 can also start to be driven at the same time of opening the suction port 23. The order of Steps S102 to S104 in FIG. 14 is not limited to this. Other orders of these steps can be applied, and also these steps can be performed at the same time.

When the drive unit 27 drives the plane plate 22 for the time enough to remove the bubble, it stops driving the plane plate 22 (FIG. 14: Step S105). For example, when the drive unit 27 goes and returns twice in the immersion area, it stops driving the plane plate 22. However, the present embodiment is not limited to this, the drive unit 27 may stop driving the plane plate 22 when the plane plate 22 goes and returns once or three times or more. A timer circuit for measuring the drive time of the plane plate 22 can also be provided. The timer circuit stops driving the plane plate 22 by the drive unit 27 in accordance with the measured drive time. Thus, the timer circuit, for example, can control to stop driving the plane plate 22 after driving the plane plate 22 for 30 sec. The condition for stopping the plane plate 22 is determined by the time needed to remove the bubble, the distance the suction port 23 moves, or the like.

The time of the initial filling of the liquid 18 is finished by stopping the drive of the plane plate 22. When the steps of initial filling from Step S101 to Step S105 in FIG. 14 is finished, the wafer stage 7 which mounts the wafer 6 is moved to below the optical element 5 (FIG. 14: Step S106). When the wafer stage 7 moves, the exposure apparatus sequentially exposes the wafer 6 (FIG. 14: Step S107).

In order to more certainly reduce the risk that the bubble in the exposure area below the optical element 5 remains, it is desirable that the plane plate 22 is driven so that the moving area where the suction port 23 moves is the same as that of the exposure area or broader than the exposure area.

The bubble is easily trapped at the gap or the edge part. Therefore, in order to more certainly reduce the risk that the bubble remains in the liquid 18, it is desirable that the plane plate 22 is driven so that the moving area where the suction port 23 moves is the same as that of the wetted part or broader than the wetted part. Thus, the bubble trapped at the gap or the edge part around the optical element 5 can be more certainly removed.

In the present embodiment, as shown in FIG. 5, after filling the liquid 18 by the conventional initial filling method, in other words, after finishing the process of FIGS. 5A to 5C, the suction port 23 is changed to the open state to drive the plane plate 22. However, a method of driving the plane plate 22 is not limited to this. In filling the liquid 18 by the conventional initial filling method, for example, at the same time of starting the process of FIG. 5C after the process of FIG. 5B is finished, the suction port 23 can be changed to the open state to drive the plane plate 22. In this case, the initial filling of the liquid 18 can be performed in the same time as that of the conventional method. Therefore, the bubble in the liquid 18 can be effectively removed without deteriorating throughput.

In the present embodiment, although the removal of the bubble remaining in the liquid 18 at the time of the initial filling is described, the same is true for the case where the liquid 18 is removed from below the optical element 5. Also in the case of removing the liquid 18, the liquid 18 is easily remained at the step, the groove, the gap, the edge part, or the interface of areas where the surface states are different. Therefore, the residual liquid can be effectively removed by changing the suction port 23 to the open state and driving the plane plate 22. As a result, the risk of water leakage after removing the liquid 18 can be reduced.

According to the device manufacturing method which includes the step of exposing the substrate (wafer) using the exposure apparatus of the present embodiment, a device in which a preferred exposing pattern is formed can be manufactured.

### Embodiment 2

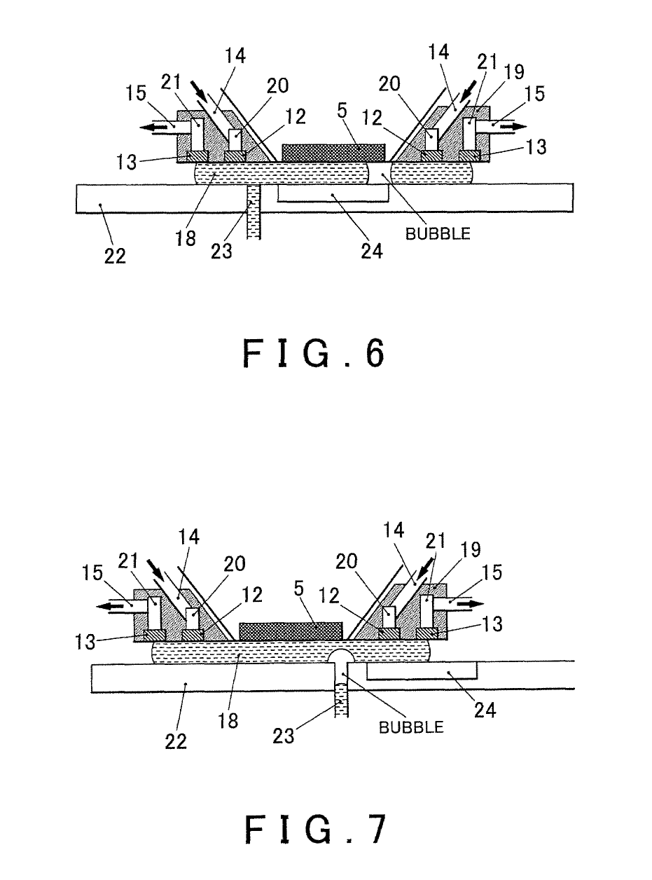

Next, the exposure apparatus of embodiment 2 will be described with reference to FIGS. 6 and 7.

FIGS. 6 and 7 are side views showing the schematic configuration of an area adjacent to the optical element 5 in the exposure apparatus of the present embodiment. In FIGS. 6 and 7, the same elements as those of the exposure apparatus in embodiment 1 are represented by the same reference numerals, and the description on these elements will be omitted.

The exposure apparatus of the present embodiment is different from that of embodiment 1 in that a sensor 24 for receiving the exposure light is provided on the plane plate 22.

The exposure apparatus of the present embodiment, as shown in FIG. 6, measures whether or not the bubble exists using the sensor 24 and specifies the position (the residual position) where the bubble (the gas) is remaining. After that, as shown in FIG. 7, the plane plate 22 is moved so that the suction port 23 (suction pipe) is positioned at the bubble position which is specified by the measurement result of the sensor 24. Thus, in the present embodiment, since the residual position of the bubble can be specified by the sensor 24, the bubble can be more certainly and effectively removed.

An illuminance sensor for measuring the illuminance of the exposure light is used as the sensor 24. If the bubble exists, the exposure light irradiated on the bubble is scattered. Therefore, in the liquid 18, the illuminance of the exposure light at the position where the bubble exists is deteriorated. In other words, the illuminance at the position where the bubble exists is smaller than the illuminance at the area filled with the liquid 18 (the area where the bubble does not exist). Therefore, the plane plate 22 is moved so that the suction port 23 is positioned at the position where the measured illuminance is smaller than the illuminance at the periphery.

In the exposure apparatus of the present embodiment, since the sensor 24 measures whether or not the bubble exists, the position of the bubble can be easily specified. Therefore, the bubble generated in the liquid 18 can be effectively removed by driving the plane plate 22 so that the suction port 23 moves to the appropriate position.

As the sensor 24, instead of the illuminance sensor, a focus sensor or a sensor configured to perform aberration measurement can also be used. At the residual position of the bubble, the defocus occurs and the aberration deteriorates. Therefore, even if the focus sensor or the sensor configured to perform the aberration measurement is used, the residual position of the bubble can be specified.

In the exposure apparatus of the present embodiment, the plane plate 22 is configured to be driven independently from the wafer stage 7. The plane plate 22 is driven by the drive unit 27. The plane plate 22 is provided with the sensor 24 for specifying the position of the bubble. However, the sensor 24 can be provided on the position other than the plane plate 22. For example, the sensor 24 can be provided on the drive unit 27. In this case, as in the case described above, the position of the bubble in the liquid 18 can be specified and the bubble can be effectively removed.

In the exposure apparatus of the present embodiment or embodiment 1, the plane plate 22 is configured to be driven independently from the wafer stage 7 using the drive unit 27. However, the wafer stage 7 can also be used as the drive unit. In this case, the support plate 9 has a function of the plane plate 22. In such a configuration, the apparatus has an advantage that it can be suppressed to get larger.

The above configuration can also be applied to embodiment 3 described below. When the support plate 9 has a function of the plane plate 22, the sensor 24 does not have to be provided on the support plate 9. Instead of the support plate 9, the sensor 24 may be provided on the wafer stage 7.

In the exposure apparatus of the present embodiment or embodiment 1, there is one wafer stage 7 (single stage). However, the configuration of the present embodiment or embodiment 1 can also be applied to the case where two wafer stages 7 (twin stage) are provided.

When the twin stage is adopted, the plane plate 22 may be configured independently from the twin stage, or the support plate 9 which supports at least one of the two stages may have a function of the plane plate 22. If the function of the plane plate 22 is provided to all stages, the productivity can be more improved. The above configuration can also be applied to embodiment 3 described below.

In the exposure apparatus of the present embodiment or embodiment 1, although the drive of the plane plate 22 for removing the bubble is performed at the time of the initial filling, it may also be performed at an appropriate time after the initial filling. For example, in the exposure apparatus configured to always keep the liquid 18 (regular immersion state) in the space between the optical element 5 and the wafer 6 (immersion area), the process of the wafer 6 is performed continuously after the initial filling of the liquid 18. In this case, for example, the plane plate 22 may be driven for removing the bubble at a rot finishing time or the like. According to such a configuration, even if the exposure apparatus adopts the regular immersion state, stably, the bubble generated in the liquid 18 can be effectively removed.

### Embodiment 3

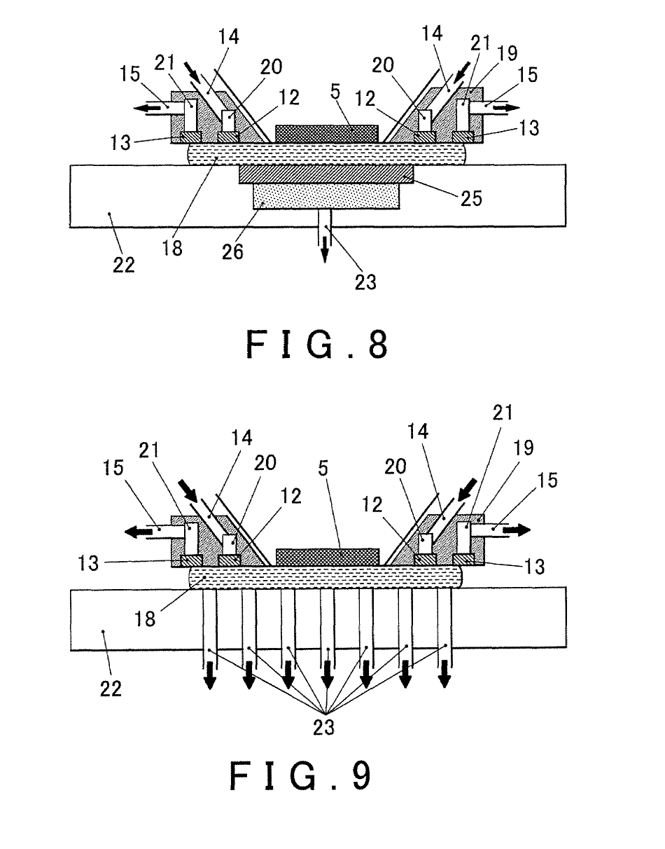

Next, an exposure apparatus of embodiment 3 will be described with reference to FIG. 8.

FIG. 8 is a side view showing a schematic configuration of an area adjacent to the optical element 5 in the exposure apparatus of the present embodiment. In FIG. 8, the same elements as those of the exposure apparatus in embodiment 1 are represented by the same reference numerals, and the description on these elements will be omitted.

The exposure apparatus of the present embodiment is different from that of embodiment 1 in that a suction member 25 is provided on the plane plate 22. It is preferable that the suction member 25 is formed broader than an exposure area and broader than a wetted part of the optical element 5 (a part where the optical element 5 is wetted with the liquid 18).

In FIG. 8, a buffer space 26 is provided below the suction member 25 so that the liquid 18 or the gas (bubble) can be suctioned evenly from almost all areas of the suction member 25.

The suction member 25 is required to suction the liquid 18 or the gas (bubble) in a state where a suction amount does not vary depending upon the location and the in-plane flow velocity distribution is nearly even. Therefore, it is preferable that a porous plate on which a plurality of small holes are arranged is used as the suction member 25. Instead, a metal or a resin which is used for a filter or the like, a sintered material made of minerals, or a porous member such as a form material and a textile material may also be used. Furthermore, these members may be laminated.

In the exposure apparatus of the present embodiment, the suction member 25 is formed so as to be broader than the wetted part of the optical element 5. Therefore, even if the bubble is trapped at the step, the groove, the gap, the edge part, or the interface of areas where the surface states are different, which is located at the periphery of the optical element 5, the suction member 25 can immediately remove the bubble. As a result, the exposure apparatus can effectively remove the bubble in the liquid 18 below the optical element 5 and can reduce the risk that the bubble 18 remains in the liquid 18.

As described above, in the exposure apparatus of the present embodiment, the suction member 25 is formed so as to be broader than the wetted part of the optical element 5. However, the size of the suction member 25 is not limited to this. In accordance with the arrangement of the space in the apparatus, it is sometimes difficult to form the suction member 25 so as to be broader than the wetted part of the optical element 25. In this case, the suction member 25 may be formed so as to be broader than the exposure area. Since such a configuration can also effectively remove the bubble in the liquid 18, it can reduce the generation of the exposure defect.

In the exposure apparatus of the present embodiment, the suction part 25 which is broader than the exposure area is provided. Therefore, if the suction member 25 is changed to the open state and the bubble is suctioned by the suction port 23 (suction pipe), the bubble can be effectively removed without driving the plane plate 22. However, as in the case of embodiment 1, the plane plate 22 may be configured to be driven. If the plane plate 22 is driven, the bubble in the liquid 18 can be more certainly removed.

In the exposure apparatus of the present embodiment, it is preferable that the suction member 25 is large. Specifically, as described in the present embodiment, it is preferable that the suction member 25 is larger than the area of the wetted part of the optical element 5. It is more preferable that the suction member 25 is larger than the immersion area of the liquid 18. According to such a configuration, the bubble in the liquid 18 below the optical element 5 is certainly removed.

In the exposure apparatus of the present embodiment provided with the suction member 25, the bubble can be effectively removed without driving the plane plate 22 or with a small driving amount. Therefore, the throughput can be improved compared to the exposure apparatus of embodiment 1 or 2.

### Embodiment 4

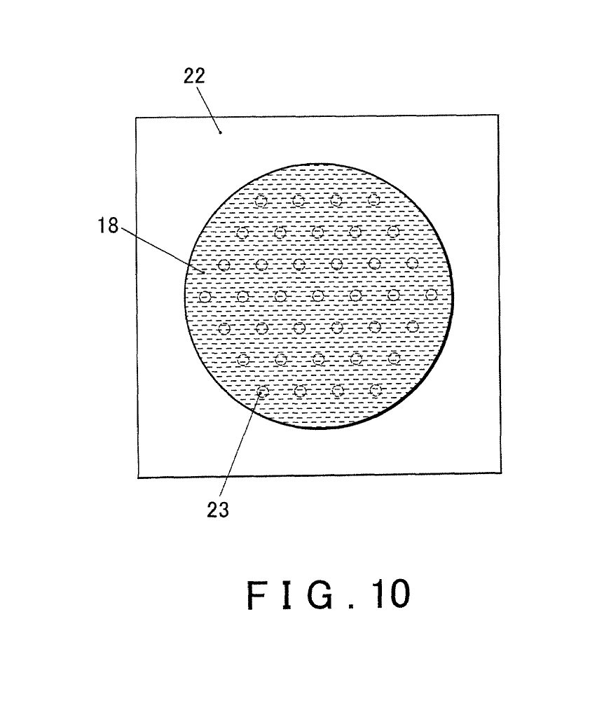

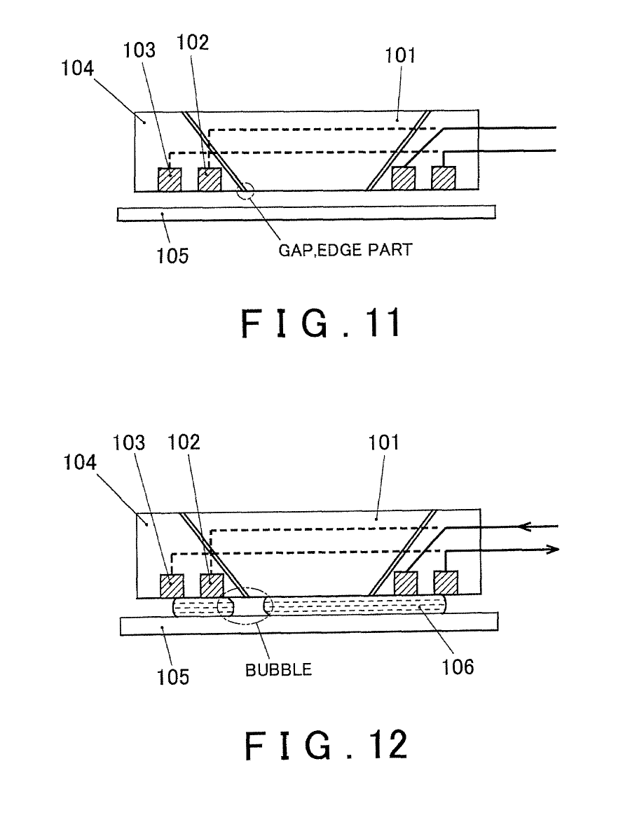

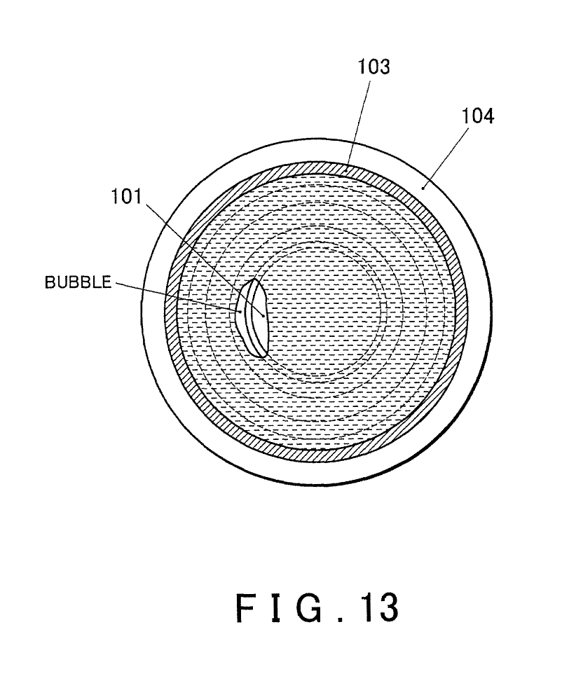

Next, the exposure apparatus of embodiment 4 will be described with reference to FIGS. 9 and 10.

FIG. 9 is a side view showing the schematic configuration of an area adjacent to the optical element 5 of the exposure apparatus of the present embodiment. FIG. 10 is a plan view looking down from the above in FIG. 9, which is a section of the area between the plane plate 22 and the optical element 5. In FIGS. 9 and 10, the same elements as those of embodiment 1 are represented by the same reference numerals, and the description on these elements will be omitted.

The exposure apparatus of FIGS. 9 and 10 is different from the exposure apparatus of embodiment 3 in that a plurality of suction ports 23 (suction pipes) are arranged in an area broader than an area of the wetted part of the optical element 5, instead of the suction member 25 of embodiment 3. In FIG. 10, only one of the suction ports 23 is represented by the reference numeral. Due to arranging the plurality of the suction ports 23, as in the case of the exposure apparatus of embodiment 3, the bubble in the liquid 18 can be more certainly removed and can reduce the risk that the bubble remains in the liquid 18.

As shown in FIG. 10, the suction port 23 is arranged so as to have a circular shape in accordance with the shape of the liquid 18. However, the arrangement is not limited to the circular shape, for example, the suction port 23 may be arranged so as to have a rectangular shape. In accordance with the shape of the liquid 18 or the optical element 5, the arrangement of the suction port can be appropriately changed.

In the exposure apparatus of FIGS. 9 and 10, thirty-seven (37) suction ports 23 are arranged. However, the number of the suction ports is not limited to this. The position where the suction ports are arranged is not limited, either. These can be arbitrarily set. For example, the suction port may be arranged so as to have the same size as that of the exposure area, or may be arranged so as to have an area broader than the area of the liquid 18.

In the exposure apparatus of the present embodiment, a plurality of the suction port 23 are provided. Therefore, if the plurality of the section port 23 are changed to the open state and the bubble is suctioned by the plurality of the suction port 23, the bubble can be effectively removed without driving the plane plate 22. However, as in the case of embodiment 1, the plane plate 22 is configured so as to be driven. If the plane plate 22 is driven, the bubble in the liquid 18 can be more certainly removed.

According to each of the above embodiments, in an immersion exposure apparatus configured to flow the liquid in the space between the projection optical system and the substrate (immersion area), the bubble generated in the immersion area can be effectively removed and the generation of the exposure defect can be reduced.

A device (a semiconductor device, a liquid crystal display device, or the like) is manufactured by passing through a process of exposing a substrate (a wafer, a glass plate, or the like) which is coated by a photosensitizing agent using the exposure apparatus of the above embodiment, a process of developing the substrate, and other well-known processes. According to this device manufacturing method, a device in which a preferred exposure pattern is formed can be manufactured.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-241740, filed on Sep. 19, 2007, which is hereby incorporated by reference herein in its entirety.

What is claimed is:

1. An exposure apparatus configured to flow liquid in an area between an optical element of a projection optical system and a wafer and to expose a pattern on a reticle onto the wafer via the projection optical system, the exposure apparatus comprising:
a supply port configured to supply the liquid to the area;
a recovery port configured to recover the liquid from the area;
a plane plate configured to be movably positioned;
a suction port which is provided on the plane plate and is configured to suction at least one of the liquid and a gas; and
a drive unit configured to move a position of the suction port by driving the plane plate in parallel to a surface of the plane plate when the suction port suctions at least one of the liquid and the gas,
wherein the drive unit drives the plane plate to move the suction port in a range broader than an exposure area.

2. An exposure apparatus according to claim 1,
wherein the drive unit drives the plane plate to move the suction port in a range broader than a wetted area of the optical element.

3. An exposure apparatus according to claim 1, further comprising a timer circuit configured to measure a driving time of the plane plate by the drive unit,
wherein the time circuit stops the drive of the plane plate by the drive unit in accordance with the measured driving time.

4. An exposure apparatus according to claim 1, further comprising a sensor configured to specify a position of the gas by receiving an exposure light,
wherein the drive unit drives the plane plate to move the suction port to the position of the gas specified by the sensor.

5. An exposure apparatus configured to flow liquid in an area between an optical element of a projection optical system and a wafer and to expose a pattern on a reticle onto the wafer via the projection optical system, the exposure apparatus comprising:
a supply port configured to supply the liquid to the area;
a recovery port configured to recover the liquid from the area;
a plane plate which is positioned opposed to the optical element;
a suction port which is provided on the plane plate and is configured to suction at least one of the liquid and a gas; and
a suction member which is provided on the plane plate and includes an opening broader than an exposure area,
wherein at least one of the liquid and the gas is suctioned to the suction port via the suction member.

6. An exposure apparatus according to claim 5,
wherein the suction member is a porous plate which has a plurality of though-holes.

7. An exposure apparatus according to claim 5,
wherein the suction member includes a porous member.

8. An exposure apparatus configured to flow liquid in an area between an optical element of a projection optical system and a wafer and to expose a pattern on a reticle onto the wafer via the projection optical system, the exposure apparatus comprising:
a supply port configured to supply the liquid to the area;
a recovery port configured to recover the liquid from the area;
a plane plate which is positioned opposed to the optical element; and
a plurality of suction ports which are provided on the plane plate and is configured to suction at least one of the liquid and a gas,
wherein the plurality of the suction ports are positioned in a range broader than an exposure area.

9. A method of manufacturing a device comprising the step of exposing a wafer using an exposure apparatus configured to flow liquid in an area between an optical element of a projection optical system and the wafer and to expose a pattern on a reticle onto the wafer via the projection optical system, the exposure apparatus comprising:
a supply port configured to supply the liquid to the area;
a recovery port configured to recover the liquid from the area;
a plane plate configured to be movably positioned;
a suction port which is provided on the plane plate and is configured to suction at least one of the liquid and a gas; and
a drive unit configured to move a position of the suction port by driving the plane plate in parallel to a surface of the plane plate when the suction port suctions at least one of the liquid and the gas,
wherein the drive unit drives the plane plate to move the suction port in a range broader than an exposure area.
